(19) United States
(12) Patent Application Publication
(10) Pub. No.: US 2005/0080730 A1
(43) Pub. Date: Apr. 14, 2005

(54) System and method for secure account transactions

(75) Inventor: Rafael Sorrentino, Papillion, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/951,459

(22) Filed: Sep. 27, 2004

Related U.S. Application Data
(60) Provisional application No. 60/511,604, filed on Oct. 14, 2003.

(51) Int. Cl. G06F 17/60

(52) U.S. Cl. 705/39; 705/44

(57) ABSTRACT

A credit card management system and method wherein a customer with an account is provided a primary credit card with a credit card number and a security code thereon. A secondary presentation instrument associated with the primary credit card is issued for use in conducting on-line transactions. A database stores account information, including the security code associated with the primary account and a secondary account number associated the secondary presentation instrument. When an on-line transaction is conducted, the customer enters both the secondary account number and the security code from the credit card. The secondary presentation instrument is a paper card, a key fob, a printed record or any other virtual credit card.

### CROSS-REFERENCES TO RELATED APPLICATIONS

This application claims priority to Provisional Application Ser. No. 60/511,604, filed Oct. 14, 2003, which is hereby incorporated by reference for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

Systems for managing credit card and other financial accounts are in widespread use. These systems have become useful for a wide range of transactions, particularly as consumers become more comfortable with on-line and other paperless transactions, and increase their use of credit cards and similar instruments. Customers now use credit cards, debit cards and other presentation instruments to make purchases, obtain cash advances, check account balances and move cash between accounts. Transactions are conducted at point-of-sale terminals in retail stores, at automated teller machines, and over the Internet using personal computers.

One result of the proliferation of credit cards has been increased concerns about lost or stolen cards and card numbers, particularly credit cards used for Internet or other on-line transactions. Customers are sometimes uneasy about conducting transactions over an Internet website, since there is no physical contact with the retailer, and the customer may feel less trusting of such a retailer (i.e., less trusting that the goods ordered will in fact be delivered, or that the credit card number given to the retailer will not be used to overcharge the account or be passed on to others who may use it fraudulently). On-line retailers may have security concerns as well, since they receive card information only electronically from the customer, and are not in a good position to verify the identity of the customer (e.g., by not seeing a signed charge slip and being able to compare the signature on the slip with a signature appearing on a physical credit card).

Customers may seek to minimize security problems over the Internet by applying for an additional card separate from their primary credit card, and using the separate card for on-line transactions. If the separate card account number (intended for Internet-use only) is misappropriated, customers can simply cancel that card without having to also give up their primary card.

Retailers attempt to lessen security concerns by asking the customer for a security code in addition to the account number. A security code (sometimes referred to as “card verification value” or a “card verification code”) is often printed on the back of the physical credit card. Thus, unless the card itself has been stolen (and the thief has both the account number from the front of the card and the security code from the back), the retailer can be somewhat assured that the person using the card is the actual authorized user or customer. The use of security codes does not help, of course, if the card has been stolen. Furthermore, customers find it awkward to use a different security code for each credit card account (especially if they are using the card frequently, or use several different cards for on-line transactions).

### BRIEF SUMMARY OF THE INVENTION

There is provided in accordance with embodiments of the present invention, systems and methods for managing accounts, such as credit card accounts.

In one embodiment there is an account ID and a separate security code associated with the account. The system has a database for storing the account ID, the security code, and one or more second IDs associated with the account and used to access the account. A database management system manages the data stored in the database, storing the second ID in relation to the account ID and the security code, and permitting access to the account in response to input of both the second ID and the security code.

### BRIEF DESCRIPTION OF THE DRAWINGS

FIG. 1 is a block diagram illustrating a network and database management system for managing accounts in accordance with an embodiment of the present invention.

FIGS. 2A and 2B illustrate the front and back sides of a credit card used in connection with the system of FIG. 1.

FIG. 3 illustrates a presentation instrument issued to a cardholder in accordance with an embodiment of the present invention.

FIG. 4 illustrates a presentation instrument issued to a cardholder in the form of a key fob, in accordance with another embodiment of the invention.

FIG. 5 is a flow diagram for issuing and activating a presentation instrument, in accordance with an embodiment of the invention.

FIG. 6 is a flow diagram for using a presentation instrument to conduct a transaction, in accordance with an embodiment of the invention.

### DETAILED DESCRIPTION OF THE INVENTION

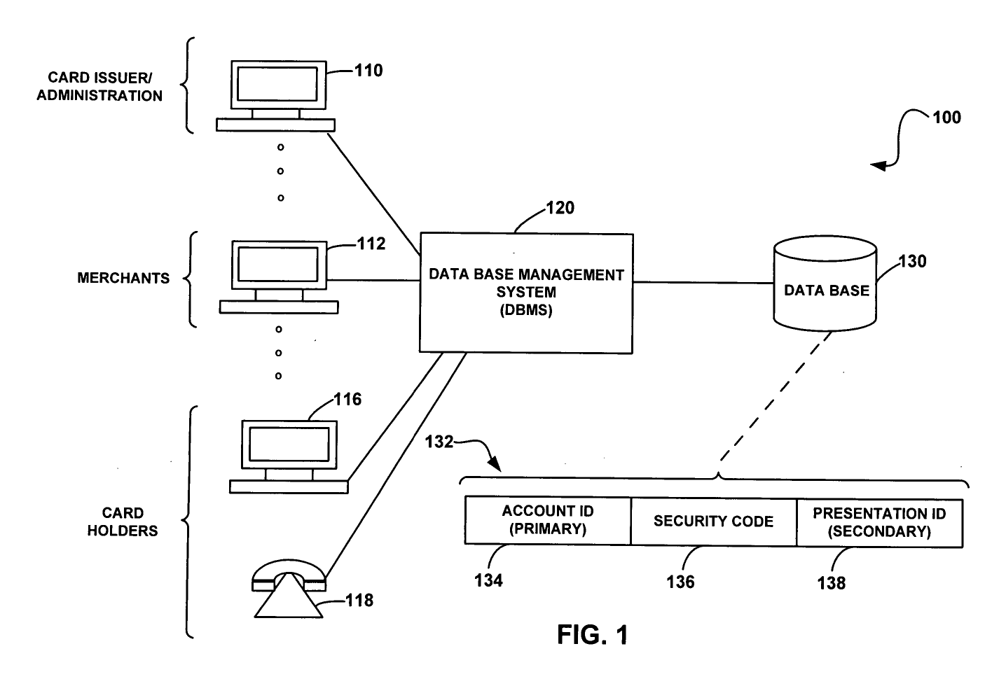

In FIG. 1, a network 100 for managing credit card accounts (and similar accounts) in accordance with one embodiment of the present invention is shown. The illustrated network 100 includes a plurality of user interface devices or terminals 110, 112, 116 and 118, a database management system (DBMS) 120, and a database 130. The terminals 110 through 118 are connected to the DBMS 120 via dedicated telecommunications/data lines or via public networks, such as the public switched telephone network (PSTN) or the Internet.

The terminal 110 is representative of a plurality of terminals used by a financial institution (e.g., a bank issuing the card and administering the cardholder account) to access the database 130. Such terminals may include internal workstations at the bank or other central location where the credit card accounts are managed. Those workstations are used by employees to enter, collect, retrieve or display data in connection with setting up credit card accounts, answering customer telephone inquiries, and performing other normal financial or business functions required for operating the credit card management network 100.

The terminal 112 is representative of a plurality of terminals that are at merchant and similar locations. Such terminals may be point-of-sale terminals at remote retail establishments, where credit card information is read or entered, along with retail transaction data (e.g., the amount of a purchase, as well as the name of the retail establishment, date, product and other useful information). Such data can be conventionally collected, such as by electronically reading data from magnetic strips/bar codes on credit cards and from product UPC (uniform product code) labels, or by being manually entered by a clerk at a terminal keyboard.

Terminals 116 and 118 are representative of terminals and other user interface devices (e.g., telephones) that are used by a cardholder to access and manage individual accounts. Thus terminal 116 may be a PC connected to DBMS 120 via the Internet, and terminal or telephone 118 may be used (through a voice recognition system at DBMS 120, not shown) for voice and/or telephone keyboard access to DBMS 120. These interface devices may be used for setting-up/activating accounts, retrieving and paying account balances, and so forth. While not illustrated in FIG. 1, the cardholder may also access (via the Internet) a merchant website for conducting on-line (electronic) transactions, and such transactions are posted to the cardholder account at database 130 by the DBMS 120 communicating with applications resident at merchants terminals 112 or other merchant systems.

The DBMS 120 can be a relational database management system that permits data in the database 130 to be created, maintained, manipulated and retrieved. The database 130 is likewise relational and, as conventional, stores data in tables, with the DBMS 120 using, for example, a structured query language (SQL) in order to maintain and operate the database. While the DBMS 120 and database 130 are relational in the described embodiment, those skilled in the art will appreciate that there are many types of databases (e.g., sequential flat files, hierarchical, object oriented, etc.) that can be used within the scope of the present invention.

The network 100 as thus far described can be implemented using known architectures and systems. In addition, a network that has the underlying architecture and systems for implementing the present invention can be found in co-pending U.S. patent application Ser. No. 10/382093, for METHOD AND SYSTEM FOR PROCESSING CREDIT CARD RELATED TRANSACTIONS, filed on Mar. 4, 2003, and owned in common with the present application. Such co-pending application is hereby incorporated by reference.

In the database 130, there is illustrated (FIG. 1) in simplified form the general content of one database table 132 used for purposes of accessing credit card accounts. The database table 132 has three fields (columns) illustrated, namely, a primary (credit card) account ID field 134, a security code field 136, and a secondary presentation (presentation instrument) ID field 138. Thus, for each account (implemented as a row in the table 132), the database maintains the account ID (the primary credit card or presentation instrument account number in the illustrated embodiment) for that account, an associated security code (usually printed on the backside of the credit card) that may be required by on-line merchants, and the secondary presentation instrument ID or account number for a secondary account (such secondary account number may be shown on a presentation instrument used by the customer, although for purposes of the invention it does need to be represented in the form of a card or any other tangible device or medium). Although not shown in FIG. 1, other data fields may also be associated with the account ID, such as account balances, account parameters (e.g., credit limits), cardholder address, cardholder telephone number, etc.

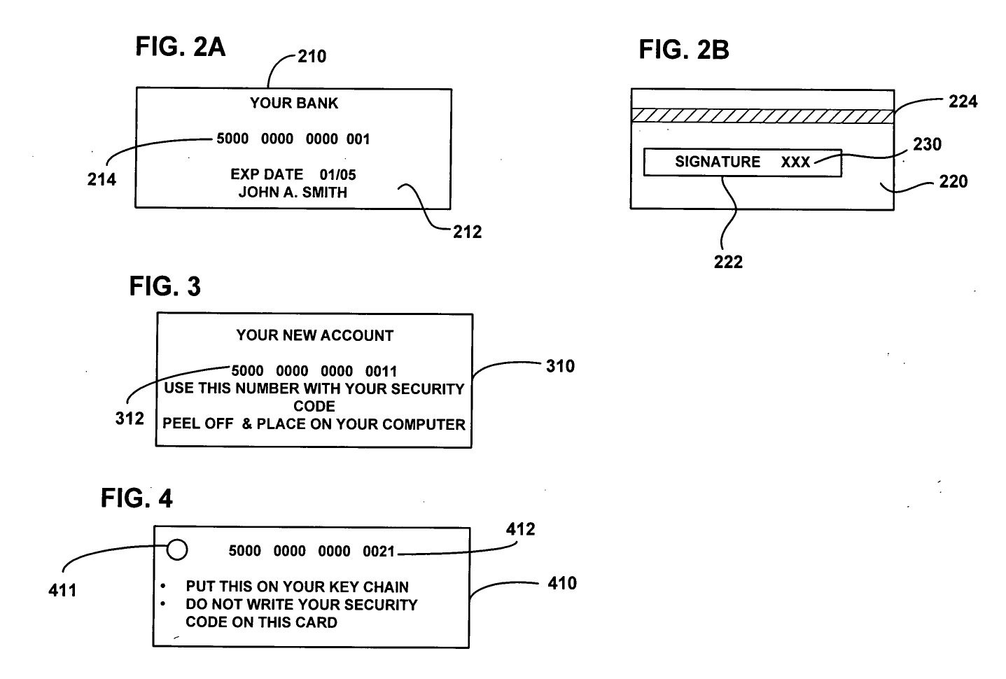

FIGS. 2A and 2B illustrate an credit card 210 that can be used in connection with the embodiment of the invention seen in FIG. 1. The front side 212 of the card includes the account number of the account (illustrated as a sixteen digit number and designated by the reference 214), an expiration date, and the name of the cardholder. The rear or backside 220 of the card has a signature block 222 and a magnetic strip 224 (e.g., for electronically storing the account number to permit the card to be swiped). As also illustrated, the signature block 222 has printed thereon a three digit security code (designated by the reference 230), which may be requested by a merchant when the cardholder conducts an electronic transaction (as is conventional, the security code is printed in a location separate from the account ID, so that it is less likely that a person other than the authorized cardholder will have access to both the account ID and the security code). While the security code 230 is illustrated as three digits, it should be apparent that it could be made up from any number or arrangement of alphanumeric or other symbols, depending on the preference of the card issuer.

In accordance with one embodiment the invention, the cardholder may choose to have a separate presentation instrument (representing a secondary account, but related to the primary account) that will be used for on-line or electronic transactions (so that for security purposes, the primary credit card or account does not have to be used for such transactions). One embodiment of such a presentation instrument 310 is illustrated in FIG. 3. As can be seen, the account number is displayed on the face of the instrument (a sixteen digit number designated by the reference 312). The instrument 310 may be paper, and although not illustrated in FIG. 3, it may be a peel and stick instrument, with adhesive on the backside that is exposed when a backing layer is peeled away. In such case it may be conveniently affixed to the housing of a personal computer (such as PC 116) or other terminal/user interface (and thus readily available for reference by the account holder when needed to enter account data). As illustrated in FIG. 3, the face (front side) of the instrument 310 may instruct the account holder to use the security code printed on the primary account card 210 (see FIG. 2B). If the instrument 310 is affixed to a stationary PC (and thus is in a secure environment ), it might also have a location (not shown in FIG. 3) for writing down the security code for convenient reference by the account holder. The presentation instrument 310 may be thought of as a virtual card, i.e., a card number (whether fixed in a tangible medium or not), but not bearing (and not having the associated cost of manufacturing) a magnetic strip or embossed or raised account information.

It should be appreciated from FIGS. 2A, 2B and 3 that the presentation instrument 310 (bearing a secondary account number) and the security code 230 on the primary card 210 provide security when conducting on-line transactions. If the primary card 210 is in the possession of the cardholder, it is unlikely that an unauthorized person will have access to both an account number (either the primary account number on card 210 or the secondary account number on instrument 310) and the cardholder security code 230. Since the primary card would not normally be used for on-line transactions, the combination of primary account number and security code are not normally provided over the Internet to on-line merchants or others, and thus risk of primary account misappropriation is reduced. Furthermore, if the secondary account number (from instrument 310) and the security code (from the primary credit card 210) are used for conducting on-line transactions, and if the secondary account number is misappropriated as a result of using it during such a transaction, the cardholder may immediately request a substitute presentation instrument 310 (with a new secondary account number) from the card issuer. Thus, the use of presentation instrument 310 does not put the primary credit card 210 and account number 214 at risk.

FIG. 4 illustrates an alternative embodiment of a presentation instrument. In FIG. 4, a presentation instrument is illustrated as a key fob 410, having an aperture 411 so that it may be placed on a key ring (not shown). The key fob 410 has the account holder's secondary account number printed thereon (a sixteen digit number designated by the reference 412). The key fob 410 may be used, for example, at locations away from the cardholder's residence or office (for example, when the account holder is at a store or other retail/transaction location and the secondary account number is needed for a transaction). In such case, the account holder will have the secondary account number conveniently available (on the face of the key fob 410) and be able to enter it as needed. While a customer will normally have secure possession of his/her keys, it might be deemed advisable not to have the security code appear on the key fob (in the event the keys are misplaced), and so as illustrated in FIG. 4 the customer is advised not to write the security code on the key fob 410. In addition, the key fob 410 could be produced with a miniature radio frequency transmitter or similar device (RFID), that automatically transmits the secondary account number to any nearby merchant terminal having a circuit for receiving the same. In such case, the customer only needs to enter the security code when requested by the merchant terminal.

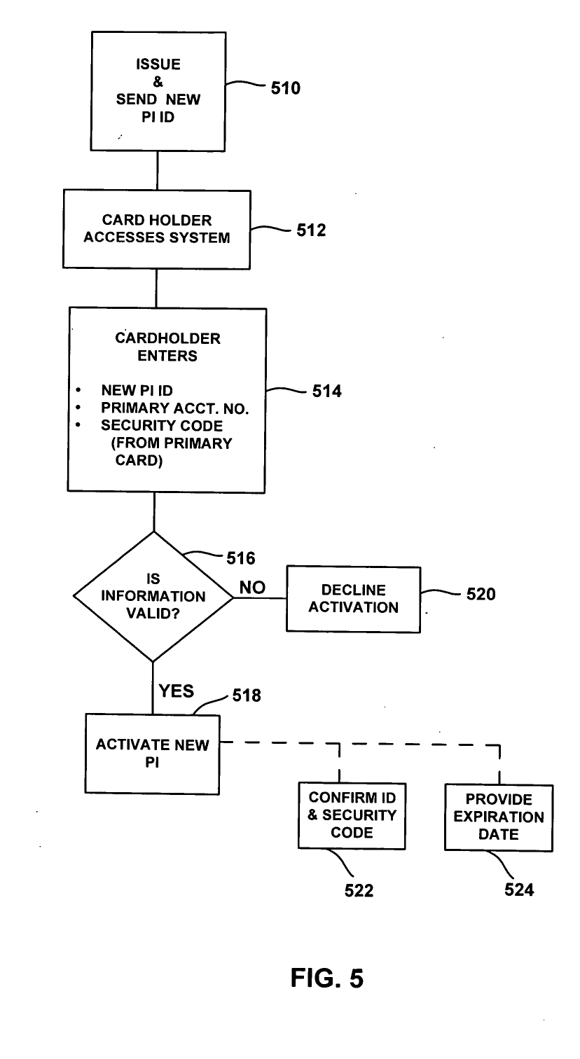

FIG. 5 illustrates an on-line process (e.g., using a telephone or the Internet) that may be used for issuing and activating a new secondary presentation instrument (PI) to a customer (i.e., to an existing card holder with an existing primary credit card account). At step 510 the new presentation instrument and account ID or number are issued by the issuer (e.g., financial institution) and sent to the customer. The new instrument may be the result of a request by the customer (e.g., by telephone or through accessing the financial institution's website), and is either mailed or sent electronically to the customer. Alternatively, the issuer may send the presentation instrument as part of an unsolicited offer, based on the customer's existing credit card account and acceptable credit risk.

In either event, the card holder may activate the presentation instrument by accessing (step 512) the issuer's system (e.g., DBMS 120 in FIG. 2), if he/she is not already in the system as part of requesting the new presentation instrument. The card holder then enters (step 514) the new account ID or number, the primary credit card account ID or number, and the security code from the back of the primary credit card (reference 230 in FIG. 2B). If the data is valid (step 516), the new presentation instrument and account number are activated (step 518). If not, the activation is declined at step 520 (e.g., an audio notice to the customer if the process is being done by telephone).

If the new presentation instrument and ID (secondary account number) are activated, the system may provide confirmation of the new secondary account number and the existing security code to be used together for transactions (optional step 522), and the customer may also be advised (step 524) of any expiration date associated with the new presentation instrument. These last two optional steps might be useful for a customer activating the new presentation instrument over the Internet, permitting a paper to be printed by the customer (such as presentation instrument 310 in FIG. 3) that confirms and makes a written record of the account information. Such record may be used by the customer when subsequently conducting a transaction with the new presentation instrument and sub account (secondary account).

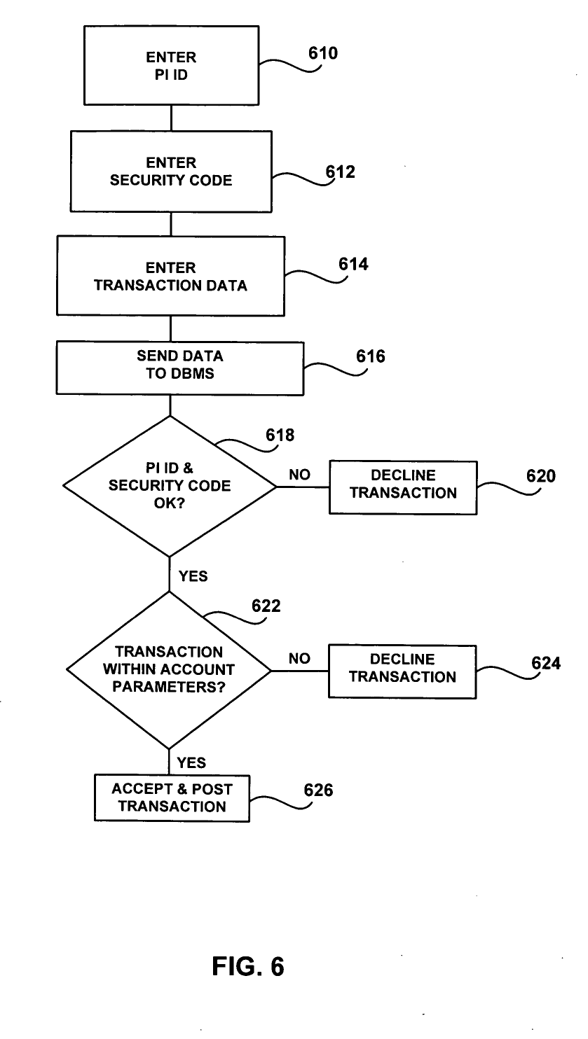

FIG. 6 illustrates a process that might be used for conducting a transaction, using the DBMS 120 and the presentation instrument (for a new sub account) resulting from the issuing and activation process of FIG. 5. In FIG. 6 it is assumed, for purposes of illustration, that the transaction is being conducted over the Internet, with the account holder accessing a merchant website, and using the secondary presentation instrument and ID for the sub account and the security code from the primary account credit card. The customer would be led through the transaction and process by screen prompts resulting from an applet or application downloaded (from the server hosting the merchant website) by a java-capable (or similar) browser running on the customer PC 116 (FIG. 1).

In FIG. 6, after the customer has chosen a transaction, he/she enters the presentation instrument ID (step 610) and then the primary account security code (step 612). The customer selects or enters the transaction data at step 614 (e.g., by indicating acceptance of items placed in an electronic shopping cart and the total purchase price for those items), and all the entered data is sent to the DBMS 120 (step 616). The DBMS 120 receives and verifies the ID and security code using the database 130 by accessing the customer's account (step 618). The transaction is declined (and a message to that effect sent to the PC 116) if the PI ID and security code do not match for that customer account (step 620). If the ID and security code are verified, the DBMS verifies (step 622) that the transaction is within account parameters (e.g., purchase price does not cause credit limits to be exceeded), and if outside those parameters, the transaction is declined (step 624). If the transaction is within account parameters, the transaction is accepted and posted to the account at the database 130 (step 626).

It can be seen from the preceding discussion that the present invention provides a novel method and system for providing and maintaining useful account information in the database 130, and provides a novel method and system for using that account information for certain transactions, such as on-line transactions. While detailed descriptions of presently preferred embodiments of the invention have been given above, various alternatives, modifications, and equivalents will be apparent to those skilled in the art without varying from the spirit of the invention. For example, the primary account instrument (illustrated in the described embodiments as credit card 210) may be an instrument other than a credit card, and in fact could be any card or instrument (e.g., debit card, ATM card, customer ID card) that is used to conduct financial or other transactions, either in person or on-line. As a further example, the secondary presentation instrument bearing the secondary or sub account number or ID (illustrated as either presentation instrument 310 or key fob 410) need not be a tangible instrument at all, but could be simply an identifier or password (e.g., string of characters) that a customer has memorized after issued by a financial or other institution, and that can be provided (along with the security code from the primary account instrument) whenever a transaction is to be conducted. As yet another example, while the described embodiments envision that the institution issuing the primary presentation instrument will also issue the secondary presentation instrument, such need not be the case. The issuer of the secondary presentation instrument could be a third party with knowledge or information concerning the primary account and the account holder's credit history, and willing to issue the secondary presentation instrument based on such information.

Therefore, the above description should not be taken as limiting the scope of the invention, which is defined by the appended claims.

1. A system for managing accounts, wherein for an account there is an account ID and a separate security code associated with the account ID, the system comprising:
a database for storing the account ID, the security code, and one or more second IDs used to access the account; and
a database management system for managing the data stored in the database, the database management system storing the second ID in relation to the account ID and the security code, and permitting access to the account in response to input of both the second ID and the security code.

2. The system of claim 1, further comprising a physical presentation instrument with the account ID thereon, and with the security code also thereon separate from the account ID.

3. The system of claim 2, wherein the presentation instrument is a credit card.

4. The system of claim 3, wherein the account ID is a credit card number.

5. The system of claim 4, wherein the credit card number is in readable form.

6. The system of claim 4, wherein the credit card number is a primary card number printed on one side of the credit card, and the security code is printed on the opposite side of the credit card.

7. The system of claim 4, wherein the credit card number is in electronically readable form.

8. The system of claim 4, wherein the credit card number is in human readable form.

9. The system of claim 2, wherein the physical presentation instrument comprises a readable portion having electronic information stored therein.

10. The system of claim 1, wherein the second ID is used for conducting transactions posted to the account ID, and is used for providing a virtual card.

11. The system of claim 10, wherein the virtual card provided by the second ID has no machine readable portion.

12. The system of claim 1, wherein the database is a relational database.

13. The system of claim 1, wherein the database management system issues a second ID in response to an electronic request from an account holder.

14. The system of claim 13, wherein the electronic request is made via the Internet.

15. The system of claim 13, wherein the electronic request is made via a telephone.

16. The system of claim 13, wherein the second ID is delivered to the customer electronically.

17. The system of claim 1, wherein the second ID is stored in the database after it is requested by an account holder.

18. A system for managing accounts, wherein for an account there is an account ID and separate security code associated with the account ID, both the account ID and the security code associated with a physical instrument, the security code for authorizing access to the account, the system comprising:
a database for storing, in relation to the account, the account ID, the security code, and one or more second IDs used to access the account; and
a database management system for managing the data stored in the database, the database management system issuing a second ID in response to an electronic request from the customer, storing the second ID in relation to the account ID and the security code, and permitting access to the account in response to input of both the second ID and the security code.

19. A method for managing accounts accessible by customers in order to conduct transactions, wherein for an account there is an associated account ID and separate security code associated with the account ID, the security code for authorizing access to the account, wherein the security code is present on a physical presentation instrument, the method comprising:
providing a database;
storing in the database the account ID, the security code associated with that account ID, and one or more secondary account IDs associated with the account ID and for use in conducting electronic transactions against the account;
structuring the database in order to relate, to the account ID, the associated security code and any associated secondary account ID; and
managing the database in order to post a transaction to the account in response to receiving transaction data with the secondary account ID and the security code associated with the account ID for that account.

20. The method of claim 19, wherein the security code is printed on the physical presentation instrument.

21. The method of claim 20, wherein physical presentation instrument is a credit card, and wherein a credit card ID is present on the credit card.

22. The method of claim 21, wherein the credit card ID and the security code are on opposite sides of the credit card.

23. The method of claim 22, wherein the credit card ID is the account ID.

24. A system for managing accounts in order to post transactions electronically against that account, wherein for an account there is an associated account ID and separate security code associated with the account ID, the security code for authenticating the identity of a customer before permitting access to the account, wherein both the account ID and the security card are imprinted on a physical presentation instrument, the system comprising:
database means for storing, in relation to the account, the account ID, the security code, and one or more secondary account IDs used to access the account; and
a database management system for permitting access to the account in response to input of both the secondary account ID and the security code.
